(19) United States
(12) Patent Application Publication
(10) Pub. No.: US 2010/0077116 A1
(43) Pub. Date: Mar. 25, 2010

(54) System for processing code data

(75) Inventors: David J. Collins, Duxbury, MA (US); Christos B. Kapsambelis, Pocasset, MA (US)

Correspondence Address: L. Joseph Marhoefer, Suite 603, 11776 Stratford House, Reston, VA, 20190, US

(73) Assignee: A2B Tracking Solutions, Inc., Portsmouth, RI (US)

(21) Appl. No.: 12/585,529

(22) Filed: Sep. 17, 2009

Related U.S. Application Data
(60) Provisional application No. 61/136,670, filed on Sep. 24, 2008.

(51) Int. Cl. G06F 13/38; G06F 3/048

(52) U.S. Cl. 710/67; 715/764

(57) ABSTRACT

A software application that is installed in a commercially available processor, which application; identifies a keystroke data stream as derived from a code pattern, stores the pattern in system memory, validates the data stream, extracts user identified fields, adds prefixes and suffixes to the fields, and transmits identified fields to the processor operating system as a keystroke emulating data stream. The DOD UID code, and other similar codes, specifies a lead character or characters as a code identifier. When the application of this invention detects this code identifying lead character it directs the processor operating system to store the character and subsequent characters in the system memory rather than process them as entries from a keyboard. The application sets a timer as each character is received. As long as the timer does not time out, each successive character in the stream is treated as part of the code data until a code specified end of data character is detected.

This application claims priority of provisional application 61/136,670 filed Sep. 24, 2008.

### FIELD OF THE INVENTION

This invention relates to an improved system for processing data derived from code patterns and more particularly to a cost effective system for processing data from scanning UID codes that encode a plurality of data fields.

### BACKGROUND OF THE INVENTION

The ubiquitous bar code label used on products and shown in FIG. 1 is a well-known example of a code pattern that encodes data that can be scanned for fast and accurate data entry into a data processing system. This uses a simple-to-create black and white pattern representing data, and can use an inexpensive scanning or camera device with a pattern decoded output that is in a form that is easily recognized by the processing system to which it is connected. In a system specifically designed to process such bar code data, the scanner output can be hard wired to the processor and a software program running on the processor can process the incoming data. For example, it can derive and display price information from the product code.

A class of scanners (so called wedge scanners) has been developed and is in wide spread commercial use to provide a simple interface between the bar code scanner and a processor system, such as a personal computer (PC). These scanners generate an output data stream that emulates a keyboard data output stream and allows the scanner to be connected to a port on the processor that accepts keyboard inputs such as a keyboard input port and the USB port. The keyboard emulating data stream from the scanner enables operating systems such as Microsoft Windows and applications used generally in a personal computer, such as spread sheet applications, to use the data from the scanner directly. For example, the PC application can enter the scanner data stream directly into the position of the active cursor as though the data was instantaneously typed in via a keyboard. When items are processed for shipment with the bar code illustrated in FIG. 1, a shipping application running on the PC can accurately record this event with the keyboard emulating scan data in the same way that it would record the event if an operator typed in the data at a cursor-prompted location for shipments. Similarly, returns can be scanned with the wedge scanner and processed as returns based on the cursor position.

A later generation of code patterns following the bar code pattern in FIG. 1 is a two-dimensional code pattern (2-D code). This 2-D code can, in a comparable or even smaller area, encode much more data than can the older bar code pattern illustrated in FIG. 1. Recently, the U.S. Department of Defense (DOD) regulations require all significant items in their possession to be marked with a 2-D code that includes a number of data fields that provide primary and secondary item identification. This invention will be described with reference to the DOD specified UID code called Data Matrix and described in detail in co-pending application Ser. No. 11/636,481 filed Dec. 11, 2006 entitled System and Method for Validating Asset Tracking Codes, assigned to the assignee of this invention, and incorporated herein by reference. However, it will be appreciated that the teachings invention are applicable generally to data read from a code pattern and outputted in a keyboard emulating data stream that includes a number of data fields from which fields data must be extracted.

FIG. 2 is an example of the DOD specified UID code, showing the markings and related data in a simple form. The disadvantage of this and similar codes is there is no direct translation of the symbol data into a meaningful data output that can represent keystroke emulating data to an IT system.

### SUMMARY OF THE INVENTION

An object of this invention is to a system application that allows existing commercially available processor hardware, operating systems and applications to act on a keystroke emulating data stream that encodes a number of diverse data fields derived from a code pattern.

A more specific object of the invention is the provision for existing systems of a software application that intercepts the UID data stream emulating a keystroke input to the system at a low level of the systems operating keyboard routine. The application detects the code data stream, blocks it temporally from further processing, and stores it in the system memory. The application tests the stored data to see if it is valid code data, extracts from the plurality of data fields, those specified by user selected prefix and suffix data, and transmits the resultant data string to the system keyboard routine emulating a keyboard entry. The prefix and suffix allow the user to specify characters that are to be used for further indication of a transaction, and to navigate within a form on the screen or to navigate to a different form.

Briefly, this invention contemplates the provision of a software application that is installed in a commercially available processor, which application; identifies a keystroke data stream as derived from a code pattern, stores the pattern in system memory, validates the data stream, extracts user identified fields, adds prefixes and suffixes to the fields, and transmits identified fields to the processor operating system as a keystroke emulating data stream. The DOD UID code, and other similar codes, specifies a lead character or characters as a code identifier. When the application of this invention detects this code identifying lead character it directs the processor operating system to store the character and subsequent characters in the system memory rather than process them as entries from a keyboard. The application sets a timer as each character is received. As long as the timer does not time out, each successive character in the stream is treated as part of the code data until a code specified end of data character is detected. If the timer times out, the characters are interpreted as from the keyboard and transferred to the operating system as such. As pointed out above, the application tests the stored data to see if it is valid code data, extracts from the plurality of data fields, those specified by user selected prefix and suffix data, and transmits the resultant data string to the system keyboard routine emulating a keyboard entry. The prefix and suffix allow the user to specify characters that can be used for further indication of a transaction, and to navigate within a form on the screen or to navigate to a different form.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a standard bar code label.

FIG. 2 is an illustration of the code fields in a DOD specified code.

FIG. 3 is a pictorial diagram of a typical, commercially available, computer system and code scanner in which the code handler application of this invention has been installed.

FIG. 4 is a logic diagram of a code handler application in accordance with the teaching of this invention.

FIG. 5 is a pictorial representation of a drop down screen interface for user selection of prefixes and suffixes that can be inserted in a selected code field.

FIG. 6 is a flow chart of the steps for processing complex code information in accordance with the teachings of this invention.

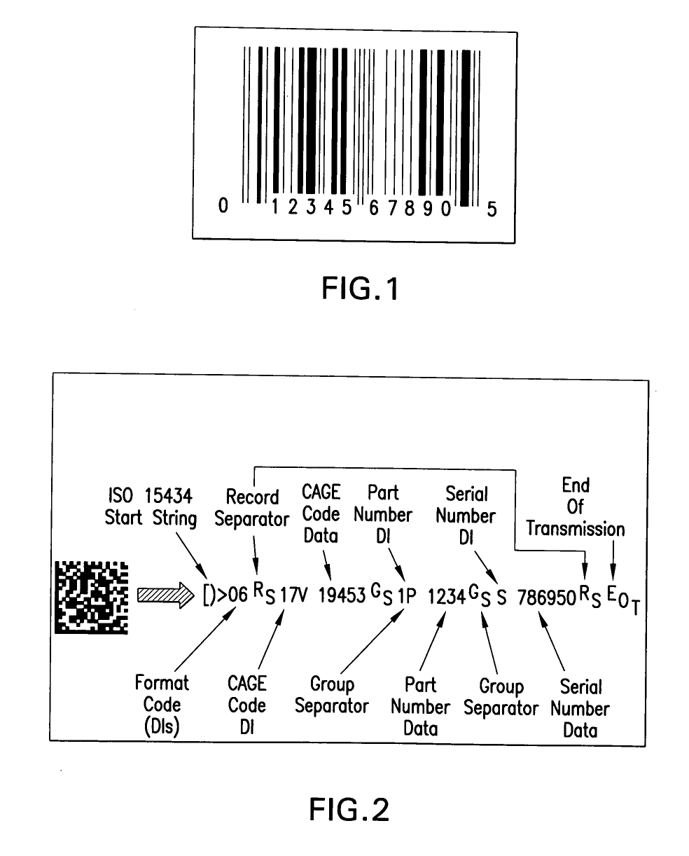

### DETAILED DESCRIPTION OF THE INVENTION

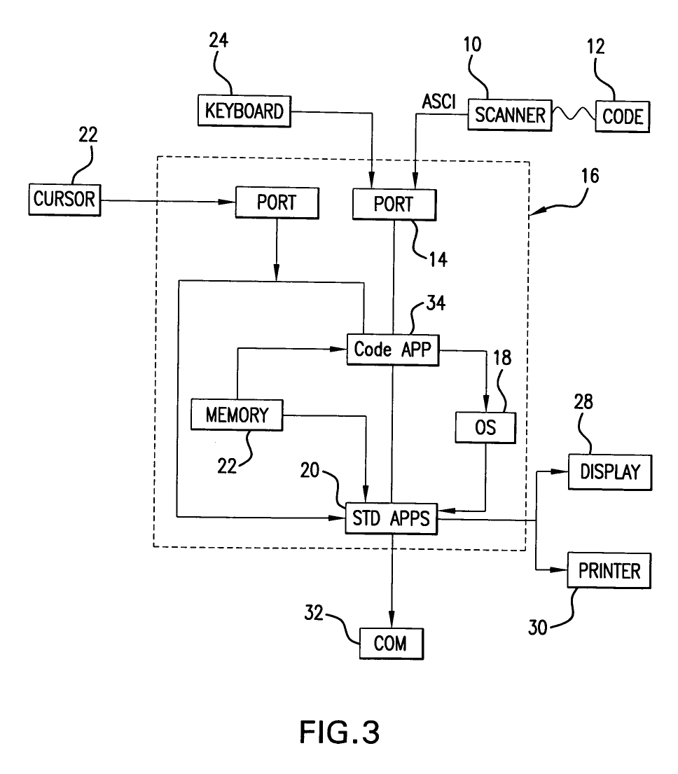

Referring now to FIG. 3, a commercially available scanner 10 scans a code pattern 12 and generates a keyboard emulating data stream. In this specific embodiment of the invention, the pattern is assumed to be a 2-D pattern encoding data in accordance with the DOD specified UID code described in detail in co-pending application Ser. No. 11/636,481 and DOD issued specifications. The scanner 10 is represented as a laser scanner. However, it will be appreciated the teachings of invention applicable to complex code patterns that include several data fields and other scanners and code patterns such as RFID. The keyboard emulating data stream output of the scanner (ASCI) is connected to the keyboard/UBS input port 14 of commercially available computer 16 within the dotted box. Only certain of the components of the computer 16 are illustrated here. These include an operating system 18, such as. Microsoft Windows, and standard applications responsive to keyboard data inputs, such as word processing applications, and spread sheet applications, denoted by box 20. The computer system includes a memory 22, inputs from a keyboard 24 also connected to the port 14 and a graphical user interface 26, such as a mouse, and outputs to a display 28, a printer 30, and a communications network 32. The system also includes a complex code processing application 34 in accordance with the teachings of this invention.

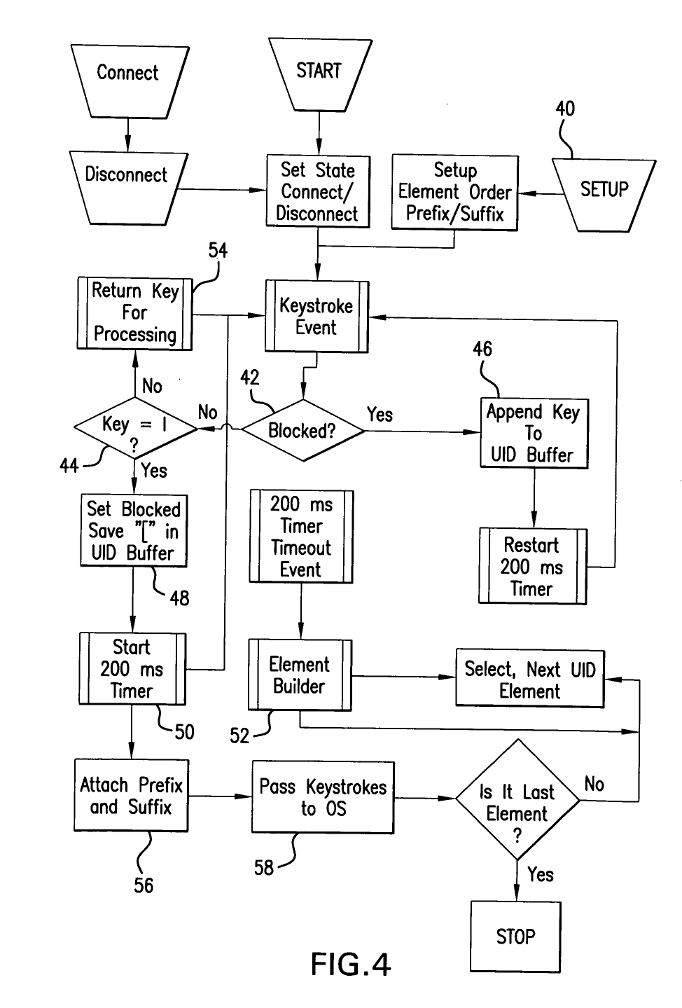

Referring now to FIG. 4, the UID element wedge application in accordance with the teachings of this invention includes a routine (SETUP block 40) that allows a user to input, via a keyboard or a cursor for example, how he or she wants each of the various selected data elements (e.g. UII, EID, part number, serial number, etc) to be processed by the Operating System after the data element has been extracted from the UID data stream. With the UID element wedge application in a connected state, keystroke event inputs are blocked from a UID buffer section in memory 22 (block 42). Upon detection of a character (block 44) that signifies the start of a UDI data stream (a left-hand bracket “[” in the specific embodiment), block 48 sets decision block 42, causes the program at block 46 to store successive characters in the UID buffer and starts a timer, block 50.

The UID Element Wedge software shown in FIG. 3 operates at a point in the Operating System to receive notice of a keystroke together with the actual character code of the depressed key. Keystroke events can be caused by the actual typing on the keyboard or by a UID scanner in a wedge operating mode that sends a series of keystroke encoded characters representing the individual characters encoded in the UID symbol read by the scanner.

The block 50 timer in this specific embodiment is a 200 ms timer and is used to determine the type of keystroke events. Keystroke events separated by an interval greater than 200 ms are treated as from a keyboard and keystroke events separated by an interval less than 200 ms as from a scanner. In the unblocked state of the application, the timer is reset after each keystroke. In some applications the interval may be different. The 200 ms timer is used also to detect the end of a scanner input in order to begin the Element Builder process, block 52, described in detail in co-pending U.S. patent application Ser. No. 11/636,481 filed Dec. 11, 2006, which is incorporated herein by reference.

Data from a keyboard input is routinely passed on “Return Key For Processing” block, except for the “[” character, which starts the timer. On timeout, if the UID Buffer only contains the “[” character, the Element Builder process determines the contents of the buffer are not a UID and passes any characters on for normal computer handling. The UID Buffer holds the entire scanned UID code sequence. The Element Builder is the sub-process that uses the UID Buffer as an input in order to validate and extract the Elements that make up the UID code derived from the scanned symbol. Using the data from the Set-up, each element extracted by the Element Builder is prepared for being passed on the Operating System by attaching the user specified prefixes and suffixes “Attach Prefix and Suffix” block 56 and passed on to the OS “Pass Keystrokes to OS” block 58 in the order selected by the user in the Setup.

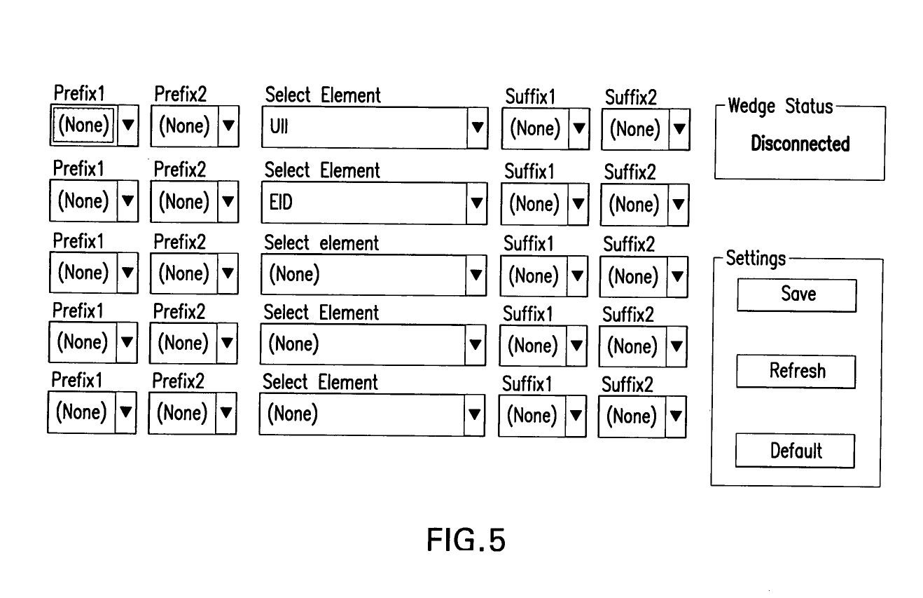

FIG. 5 illustrates a graphical user interface with drop down boxes that allow the user to select up to two prefixes and up to two suffixes for each element. A select element column with drop down boxes that contain some or all of the code elements allows the user to select those elements the user wants to be transferred to the processor and the order in which they are transferred. A none selection will cause the selection to be blank. The order of output of the code elements selected by the user via the graphical user interface will be part of the application, usually left to right, and top down. A save selection block saves the settings in the power down mode. A refresh select restores the settings to the last saved version. Default sets the settings as shown in the Figure.

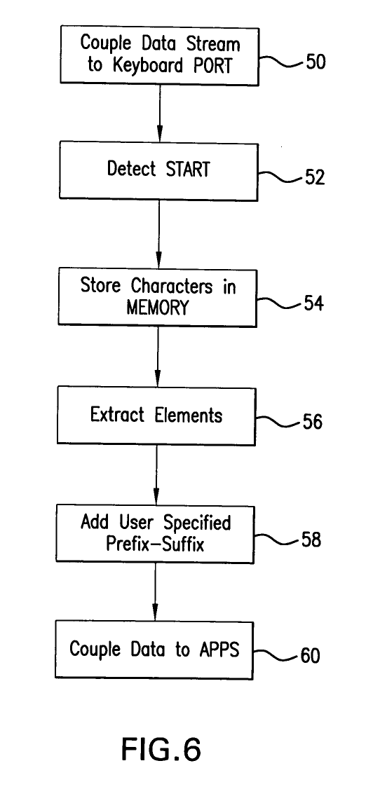

FIG. 6 outlines the steps in processing a code generated data stream that emulates a keystroke data stream. In an initial step 50, the keyboard emulating code data stream is coupled as in input to a computer via the computer port that accepts keyboard entries. Next, the process running under the computer operating system on the computer processor, detects the start of the code generated data stream, block 52. When detected, the process stores the characters of the data stream in the computer memory until the end of the stream is detected, block 54. Next, it extracts the elements or fields from the data stream, block 56 and adds a user selected prefix and suffix to certain of the extracted elements, block 58. Extracted elements, with their respective prefix and suffix data, are then coupled as keyboard data to the general application programs, such as word processing and spread sheet programs, block 60.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

1. A method for processing UID data encoded in a pattern, including the steps of:
scanning the pattern with wedge type scanner that generates a stream of UID keystroke data characters in response to the UDI data encoded in the pattern;
coupling the stream of UID keystroke data characters to an input port of a computer processor that includes a processor operating system;
blocking the stream of UID keystroke data characters coupled to the processor port from the processor operating system;
storing the stream of UID keystroke data characters coupled to the processor port in a buffer;
coupling the stream of UID keystroke data characters stored in said buffer as an input to a UID element builder routine that determines the validity of the stream as a UID code;
deriving a code stream of an element in the stream of UID keystroke data characters;
adding a string of characters pre-selected by a user within the element code stream;
coupling the code stream resulting from the just previous adding step to the operating system in a manner emulating a keyboard entry.

2. A method for encoding UID data as in claim 1 including the further step of distinguishing between keystroke events as a result of said scanning step and keystroke events as a result of a keyboard input based on the repetition rate of the keystroke events as a result of said scanning step a compared to the repetition rate of the keystroke events as a result of the keyboard input.

3. A method for encoding UID data as in claim 1 including the step of selecting the code stream of an element in said deriving step by means of a graphical user interface.

4. A method for encoding UID data as in claim 2 including the step of selecting the code stream of an element in said deriving step by means of a graphical user interface.

5. A method for encoding UID data as in claim 1 including the step of selecting the string of characters in said adding step by means of a graphical user interface.

6. A method for encoding UID data as in claim 2 including the step of selecting the string of characters in said adding step by means of a graphical user interface.

7. A method for encoding UID data as in claim 3 including the step of selecting the string of characters in said adding step by means of a graphical user interface.

8. A method for encoding UID data as in claim 3 including the step of selecting the string of characters in said adding step by means of a graphical user interface.

9. A method for encoding UID data as in claim 4 including the step of selecting the string of characters in said adding step by means of a graphical user interface.
